(19) United States
(12) Patent Application Publication
(10) Pub. No.: US 2007/0224697 A1
(43) Pub. Date: Sep. 27, 2007

(54) Means and method for analyzing samples by mass spectrometry

(75) Inventor: Melvin A. Park, Billerica, MA (US)

Correspondence Address: LAW OFFICES OF PAUL E. KUDIRKA, 40 BROAD STREET, SUITE 300, BOSTON, MA, 02109, US

(73) Assignee: Bruker Daltonics, Inc., Billerica, MA (US)

(21) Appl. No.: 11/388,745

(22) Filed: Mar. 24, 2006

(51) Int. Cl. G01N 24/00

(52) U.S. Cl. 436/173

(57) ABSTRACT

Disclosed is an improved method for performing a mass spectrometric analysis of a sample. More specifically, the present invention provides a method wherein analyte is transferred in a spatially coherent manner from a sample to the surface of a semiconductor. Laser light is used to produce gas phase ions directly from analyte adsorbed to the semiconductor surface. Analyte ions and the mass spectra produced therefrom are used to determine the distribution of analyte on the surface of the sample.

### FIELD OF THE INVENTION

The present invention generally relates to an improved method and apparatus for the analysis of samples by mass spectrometry.

### BACKGROUND OF THE INVENTION

The present invention relates to methods for the analysis of samples by mass spectrometry. The apparatus and methods for sample handling and analysis described herein are enhancements of the techniques referred to in the literature relating to mass spectrometry—an important tool in the analysis of a wide range of chemical compounds. Specifically, mass spectrometers can be used to determine the molecular weight of sample compounds. The analysis of samples by mass spectrometry consists of three main steps—formation of gas phase ions from sample material, mass analysis of the ions to separate the ions from one another according to ion mass, and detection of the ions. A variety of means and methods exist in the field of mass spectrometry to perform each of these three functions. The particular combination of the means and methods used in a given mass spectrometer determine the characteristics of that instrument.

To mass analyze ions, for example, one might use magnetic (B) or electrostatic (E) analysis, wherein ions passing through a magnetic or electrostatic field will follow a curved path. In a magnetic field, the curvature of the path will be indicative of the momentum-to-charge ratio of the ion. In an electrostatic field, the curvature of the path will be indicative of the energy-to-charge ratio of the ion. If magnetic and electrostatic analyzers are used consecutively, then both the momentum-to-charge and energy-to-charge ratios of the ions will be known and the mass of the ion will thereby be determined. Other mass analyzers are the quadrupole (Q), the ion cyclotron resonance (ICR), the time-of-flight (TOF), and the quadrupole ion trap analyzers. The analyzer used in conjunction with the method described here may be any of a variety of these.

Before mass analysis can begin, gas phase ions must be formed from a sample material. If the sample material is sufficiently volatile, ions may be formed by electron ionization (EI) or chemical ionization (CI) of the gas phase sample molecules. Alternatively, for solid samples (e.g., semiconductors, or crystallized materials), ions can be formed by desorption and ionization of sample molecules by bombardment with high energy particles. Further, Secondary Ion Mass Spectrometry (SIMS), for example, uses keV ions to desorb and ionize sample material. In the SIMS process a large amount of energy is deposited in the analyte molecules, resulting in the fragmentation of fragile molecules. This fragmentation is undesirable in that information regarding the original composition of the sample (e.g., the molecular weight of sample molecules) will be lost.

For more labile, fragile molecules, other ionization methods now exist. The plasma desorption (PD) technique was introduced by Macfarlane et al. (R. D. Macfarlane, R. P. Skowronski, D. F. Torgerson, Biochem. Biophys. Res Commoun. 60 (1974) 616) (“McFarlane”). Macfarlane discovered that the impact of high energy (MeV) ions on a surface, like SIMS would cause desorption and ionization of small analyte molecules. However, unlike SIMS, the PD process also results in the desorption of larger, more labile species (e.g., insulin and other protein molecules).

Additionally, lasers have been used in a similar manner to induce desorption of biological or other labile molecules. See, for example, Cotter et al. (R. B. VanBreeman, M. Snow, R. J. Cotter, Int. J. Mass Spectrom. Ion Phys. 49 (1983) 35; Tabet, J. C.; Cotter, R. J., Tabet, J. C., Anal. Chem. 56 (1984) 1662; or R. J. Cotter, P. Demirev, I. Lys, J. K. Olthoff, J. K.; Lys, I.: Demirev, P.: Cotter et al., R. J., Anal. Instrument. 16 (1987) 93). Cotter modified a CVC 2000 time-of-flight mass spectrometer for infrared laser desorption of non-volatile biomolecules, using a Tachisto (Needham, Mass.) model 215G pulsed carbon dioxide laser. The plasma or laser desorption and ionization of labile molecules relies on the deposition of little or no energy in the analyte molecules of interest.

The use of lasers to desorb and ionize labile molecules intact was enhanced by the introduction of matrix assisted laser desorption ionization (MALDI) (K. Tanaka, H. Waki, Y. Ido, S. Akita, Y. Yoshida, T. Yoshica, Rapid Commun. Mass Spectrom. 2 (1988) 151 and M. Karas, F. Hillenkamp, Anal. Chem. 60 (1988) 2299). In the MALDI process, an analyte is dissolved in a solid, organic matrix. Laser light of a wavelength that is absorbed by the solid matrix but not by the analyte is used to excite the sample. Thus, the matrix is excited directly by the laser, and the excited matrix sublimes into the gas phase carrying with it the analyte molecules. The analyte molecules are then ionized by proton, electron, or cation transfer from the matrix molecules to the analyte molecules. This process (i.e., MALDI) is typically used in conjunction with time-of-flight mass spectrometry (TOFMS) and can be used to measure the molecular weights of proteins in excess of 100,000 daltons.

Further, Atmospheric Pressure Ionization (API) includes a number of ion production means and methods. Typically, analyte ions are produced from liquid solution at atmospheric pressure. One of the more widely used methods, known as electrospray ionization (ESI), was first suggested by Dole et al. (M. Dole, L. L. Mack, R. L. Hines, R. C. Mobley, L. D. Ferguson, M. B. Alice, J. Chem. Phys. 49, 2240, 1968). In the electrospray technique, analyte is dissolved in a liquid solution and sprayed from a needle. The spray is induced by the application of a potential difference between the needle and a counter electrode. The spray results in the formation of fine, charged droplets of solution containing analyte molecules. In the gas phase, the solvent evaporates leaving behind charged, gas phase, analyte ions. This method allows for very large ions to be formed. Ions as large as 1 MDa have been detected by ESI in conjunction with mass spectrometry (ESMS).

In addition to ESI, many other ion production methods might be used at atmospheric or elevated pressure. For example, MALDI has recently been adapted by Laiko et al. to work at atmospheric pressure (Victor Laiko and Alma Burlingame, “Atmospheric Pressure Matrix Assisted Laser Desorption”, U.S. Pat. No. 5,965,884, and Atmospheric Pressure Matrix Assisted Laser Desorption Ionization, poster #1121, 4^{th} International Symposium on Mass Spectrometry in the Health and Life Sciences, San Francisco, Aug. 25-29, 1998) and by Standing et al. at elevated pressures (Time of Flight Mass Spectrometry of Biomolecules with Orthogonal Injection+Collisional Cooling, poster #1272, 4^{th} International Symposium on Mass Spectrometry in the Health and Life Sciences, San Francisco, Aug. 25-29, 1998; and Orthogonal Injection TOFMS Anal. Chem. 71(13), 452A (1999)). The benefit of adapting ion sources in this manner is that the ion optics (i.e., the electrode structure and operation) in the mass analyzer and mass spectral results obtained are largely independent of the ion production method used.

The elevated pressure MALDI source disclosed by Standing differs from what is disclosed by Laiko et al. Specifically, Laiko et al. disclose a source intended to operate at substantially atmospheric pressure. In contrast, the source disclosed by Standing et al., is intended to operate at a pressure of about 70 mtorr.

Direct laser desorption/ionization (LDI) without a matrix has been extensively studied on a variety of substrates but is no longer widely used because of the success of MALDI in desorbing and ionizing a broad range of analytes. In contrast, direct LDI often results in rapid molecular degradation of the sample and fragmentation of analyte molecules.

However, MALDI has limitations in the study of small molecules. The same matrix which enhances the LDI of labile molecules also produces matrix ions which interfere with the measurement of analyte species appearing below a m/z of approximately 700. The matrix ions and therefore the resulting interferences produced, varies somewhat depending on the matrix used in the MALDI process. Although MALDI can be used for the analysis of small molecules as has been demonstrated by Lidgard, et al Rapid Comm. in Mass Spectrom. 9, 128-132 (1995) and matrix suppression can be achieved under certain circumstances as demonstrated by Knochenmuss, et al, Rapid Comm. in Mass Spectrom. 10, 871-877 (1996), matrix interference presents a real limitation on the study of the low-mass analyte by MALDI.

Even in the analysis of larger molecules, MALDI has limitations. The matrix and matrix fragments can form adducts with the analyte ion. The presence of adducts in a MALDI study can cause the signal associated with a single type of analyte to be spread over several mass spectral peaks. The effect of such adducts is thus to reduce the observed intensity of the molecular ion peak associated with the analyte and a mass spectrum of increased complexity.

Salts and buffers can also be detrimental to mass spectroscopy analyses. In addition to the negative effects salts have during sample preparation, salts often form adduct peaks in a mass spectrum that compete with the peaks of the molecular ion. As discussed with respect to matrix adduct above, salt adducts tend to divide analyte signals among several peaks and to broaden the overall signal. High pH value buffers can also interfere with ionization of the sample in MALDI or electrospray ionization (ESI) techniques. In MALDI sample preparation, salts and buffers can interfere with the formation of the matrix crystal, and result in loss of signal.

In U.S. Pat. No. 6,288,390, which is incorporated herein by reference, Siuzdak et al. describe a method for ionizing an analyte from porous light-absorbing semiconductors and then analyzing the ionized analyte. According to Siuzdak, one benefit of the invention disclosed in U.S. Pat. No. 6,288,390 “is that a substrate for desorption/ionization of analytes is utilized that does not require the use of a matrix. Even without a matrix the . . . invention can directly desorb and ionize analytes with a m/z ratio value of up to at least 12,000.” Siuzdak further discloses that the “surface properties of . . . porous silicon can be easily tailored”. Siuzdak describes “modifying the substrate to optimize the desorption/ionization characteristics of the substrate for biomolecular or other applications. Preferably, the solution can not spread widely on the substrate so that the analyte remains on a small portion of the substrate. Although porous silicon substrates can be prepared for use with the subject invention having hydrophobic, hydrophilic, or fluorophilic surfaces, the preparation of hydrophobic surfaces is preferred for biomolecular analysis.”

In U.S. Pat. No. 6,794,196, which is incorporated herein by reference, Fonash et al. describe a method of forming semiconductor films having a columnar/void network morphology. Further, Fonash et al. disclose the use of such semiconductor films for LDI mass spectrometric analysis of analytes. The method according to Fonash consists of producing a semiconductor film, depositing analyte on the film, and analyzing the sample by matrix-less light desorption/ionization mass spectroscopy.

Another type of high surface to volume ratio semiconductor film is composed of semiconducting nanowires. In U.S. patent application Ser. No. 11/117,702, which is incorporated herein by reference, Romano et al. describe a method for growing semiconductor nanowires on a growth substrate. Growth substrates include, for example, polymers, conducting or non-conducting oxides, metal foils, etc.

Mass spectrometers have long been used in the “imaging” of sample materials. Imaging here implies the generation of a plot of the intensity of a selected mass ion at the detector of the mass spectrometer as a function of the position on the sample surface that the selected ions originated from. Such images can be used to determine the distribution of analyte species over the sample surface. Secondary ion mass spectrometry (SIMS) has been used in this way to determine the distribution of elemental species over sample surfaces. SIMS imaging has frequently been used in the study of semiconductor materials. Laser desorption ionization mass spectrometry (LDIMS) in contrast has been used in the imaging of biological samples. As discussed above direct LDIMS can be used to produce ions of small biomolecules. Using LDIMS, the distribution of small biomolecules within tissue samples, for example, can be measured.

The advent of matrix assisted LDIMS opens the door for the imaging of larger biomolecules in tissues. U.S. Pat. No. 5,808,300 which is incorporated herein by reference, describes a method and apparatus for imaging biological samples with MALDI MS. U.S. Pat. Nos. 5,372,719 and 5,453,199 which are incorporated herein by reference, disclose techniques for preparing a chemically active surface. The disclosed methods involve the separation of molecules by sorbents.

In U.S. Pat. No. 6,756,586, which is incorporated herein by reference, Caprioli et al. disclose “methods and apparatuses for analyzing proteins and other biological materials and xenobiotics within a sample. A specimen is generated, which may include an energy absorbent matrix. The specimen is struck with laser beams such that the specimen releases proteins. The atomic mass of the released proteins over a range of atomic masses is measured. An atomic mass window of interest within the range of atomic masses is analyzed to determine the spatial arrangement of specific proteins within the sample, and those specific proteins are identified as a function of the spatial arrangement. By analyzing the proteins, one may monitor and classify disease within a sample.”

However the preparation and analysis of tissue samples for MALDI imaging is not yet perfected. As part of the preparation, the tissue must be coated with “matrix” material. This has been accomplished by spotting (R. Caprioli and P. Chaurand, Proceedings of the 52nd ASMS Conference on Mass Spectrometry and Allied Topics, Nashville, Tenn., May 23-27, 2004, Abstract A042930; and Richard N. Ellson, Proceedings of Nanotech and Biotech Convergence Conference, May 2003.) or by spraying (A. C. Crecelius, B. Williams, D. S. Cornett, X. Li, B. M. Dawant, R. E. Bodenheimer, M. Lepage, K. J. Nierman, and R. Caprioli. Proceedings of the 52nd ASMS Conference on Mass Spectrometry and Allied Topics, Nashville, Tenn., May 23-27, 2004, Abstract A040967, ML Reyzer and R M Caprioli, J Proteom Res 4, 1138(2005)) matrix onto the sample. Variability in depositing the matrix on the tissue can lead to poor reproducibility in the MALDI image data. Furthermore interferences from salts and other components in the tissue may lead to a signal suppression that prevent one from observing the analyte under investigation.

Finally, as discussed above, when imaging tissues directly using MALDI, matrix species tend to interfere with the measurement of analyte having molecular weights below a few hundred Dalton. This mass range covers many analyte species of interest in drug discovery and metabolomics. Thus, the study of drugs or metabolites in tissues by MALDI imaging may often be inhibited due to the presence of matrix peaks in the MALDI spectra.

### SUMMARY OF THE INVENTION

In accordance with one embodiment of the invention, analyte in a sample is blotted onto the surface of a semiconductor having a large surface-to-volume ratio. The surface of the semiconductor may be pretreated to provide an analyte selective surface coating. After blotting, the surface of the semiconductor may be washed to remove species other than analyte. The semiconductor target together with adsorbed analyte can then be analyzed by laser desorption ionization mass spectrometry.

In this embodiment, a series of LDMS spectra are obtained from an array of spots covering that region of the target exposed to the original sample. The signals observed in the series of LD mass spectra are related to species desorbed and ionized from specific positions on the target. Further, the position of a species on the target is related to the position that species had in the original sample. Thus, the distribution of one or more species in the original sample can be determined by observing selected mass signals in the LD mass spectra.

In one embodiment, one or more “mass images” are produced from the series of LDMS spectra by plotting the intensity of a given mass signal, or range of mass signals, as a function of position on the target. In this sense, each mass analyzed spot on the target represents a pixel in the image. Each mass image, thereby displays the distribution over the original sample of species of predetermined mass.

### BRIEF DESCRIPTION OF THE DRAWINGS

For a more complete understanding of the present invention, reference is now made to the following drawings in which:

FIG. 1 is a flow chart illustrating the steps of a method according to the present invention;

FIG. 2 is a depiction of a mass spectrometer that may be used with the present invention;

FIG. 3A is a depiction a sample (left) and a target (right) as used with the present invention;

FIG. 3B is a depiction of a sample placed face down on a target as used with the present invention;

FIG. 3C is a depiction a sample (left) and a target (right) as used with the present invention after blotting;

FIG. 3D is a depiction of a target and an array of target locations to be analyzed by the mass spectrometer according to the present invention; and

FIG. 3E is a mass image of the sample as formed from the analysis of the target in accordance with the present invention.

### DETAILED DESCRIPTION

As discussed above, the present invention relates generally to the mass spectroscopic analysis of chemical samples and more particularly to mass spectrometry. Specifically, a method is described for the mass spectrometric analysis of a sample. Reference is herein made to the figures, wherein the numerals representing particular parts are consistently used throughout the figures and accompanying discussion.

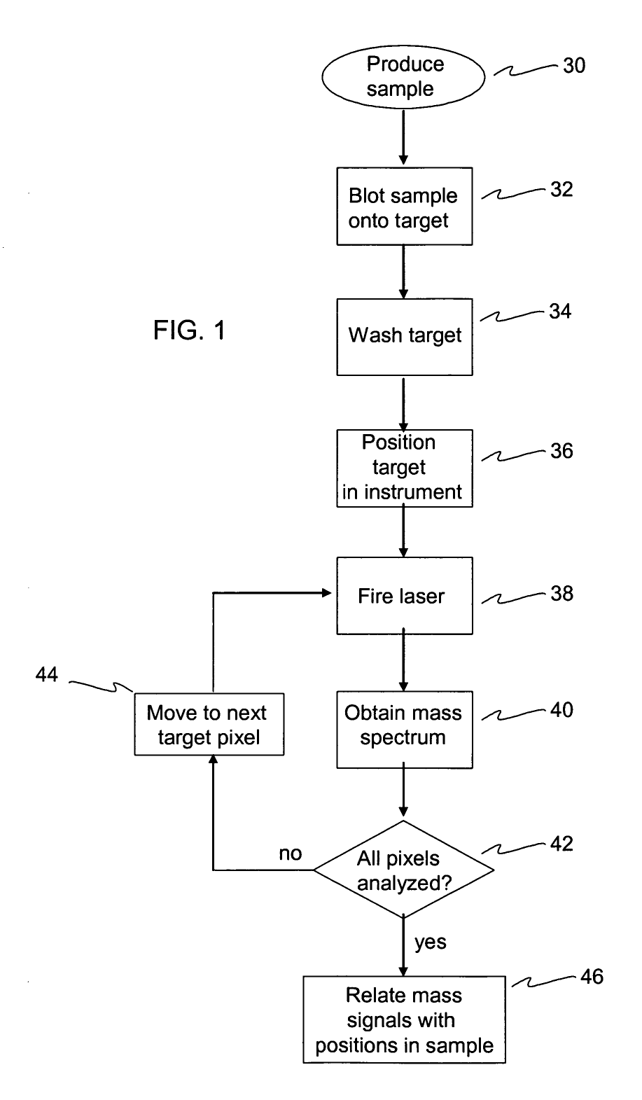

Shown in FIG. 1 is a flow chart detailing the steps of a method of the present invention. In step 30 a sample is produced. The sample may be any conceivable material but should be prepared with at least one substantially flat surface. The sample may be synthetic or natural. For example, the sample may be cloth, paper, rubber or any other synthetic material. Or, for example, the sample may be a seed, a leaf, an organ from an animal, or any other plant or animal tissue. The sample must be cut or otherwise formed in such a manner that it has at least one flat surface. It is this flat surface that will be brought into contact with the target in step 32. One possible sample might be a microtome formed from an animal tissue.

In step 32 the sample is blotted onto a target surface. The material of the target surface adsorbs analyte species out of the sample, retains the analyte as the target is being transferred into a mass spectrometer and, once in the mass spectrometer, assists in the formation of gas phase ions from the analyte. The target may have a wide variety of constructions. A key feature is that the target material to which the sample is exposed is substantially composed of a high surface to volume semiconductor. The semiconductor material may be modified, functionalized, or otherwise covered with a thin layer of material to better control the surface properties of the target. The modification, functionalization, and covering of semiconductor surfaces is well known in the prior art (see for example, U.S. Pat. No. 6,288,390). According to the present invention such a modification may be used to enhance the adsorption of an analyte of interest while reducing the adsorption of other species or contaminants.

The semiconducting material used in the target may be any semiconducting material including not only Group IV semiconductors, but also Group I-VII semiconductors (for example CuF, CuCl, CuBr, CuI, AgBr, and Agl), Group II-VI semiconductors (for example BeO, BeS, BeSe, BeTe, BePo, MgTe, ZnO, ZnS, ZnSe, ZnTe, ZnPo, CdS, CdSe, CdTe, CdPo, HgS, HgSe, and HgTe), Group III-V semiconductors (for example BN, BP, BAs, AlN, AlP, AlAs, AlSb, GaN, GaP, GaSb, InN, InAs, InSb), Sphaelerite Structure Semiconductors (for example MnS, MnSe, Ga₂ Te₃, In₂ Te₃, MgGeP₂, ZnSnP₂, and ZnSnAs₂), Wurtzite Structure Compounds (for example NaS, MnSe, SiC, MnTe, Al₂S₃, and Al₂Se₃), and I-II-VI₂ semiconductors (for example CuAlS₂, CuAlSe₂, CuAITe₂, CuGaS₂, CuGaSe₂, CuGaTe₂, CuInS₂, CuInSe₂, CuInTe₂, CuTIS₂, CuTISe₂, CuFeS₂, CuFeSe₂, CuLaS₂, AgAS₂, AgAISe₂, AgAITe₂, AgGaS₂, AgGaSe₂, AgGaTe₂, AgInS₂, AgInSe₂, AgInTe₂, AgFeS₂).

The target surface should also have a high surface to volume ratio. Such a high surface to volume ratio may be attained by the formation of a structured surface. For example, a porous structure might be formed as described by Siuzdak et al. in U.S. Pat. No. 6,288,390. Alternatively, a surface covered by nanowires might be formed as described by Romano et al. in U.S. patent application Ser. No. 11/117,702. Another alternative is a columnar/void network morphology as disclosed by Fonash et al. in U.S. Pat. No. 6,794,196. Any other known method of forming high surface to volume semiconducting surfaces might also be used.

As mentioned above, the semiconductor surface might be covered, modified, or functionalized by any of a variety of methods known in the prior art. As an example, Trauger et al. describe the modification of a porous silicon surface by reaction with perfluorophenyldimethychlorosilane (S. A. Trauger, E. P. Go, Z. Shen, J. V. Apon, E. S. P. Bouvier, and G. Siuzdak, Proceedings of the 52nd ASMS Conference on Mass Spectrometry and Allied Topics, Nashville, Tenn., May 23-27, 2004, Abstract A042030). Such modification can be used to produce a surface having a variety of desirable properties. For example, the surface may be made to be hydrophobic or hydrophilic or the surface be made selective towards a class of analytes. As a further example, functionalizing the semiconductor surface with a fluorocarbon will cause the surface to be hydrophobic. This will cause hydrophobic compounds to preferentially adsorb to the surface out of a water solution.

The target can be constructed in a wide variety of ways, however, in the preferred embodiment, the above mentioned semiconductor material is deposited or otherwise formed on a flat plate of solid metal or other conducting material—for example, stainless steel. The macroscopic dimensions of the target may be any selected dimension. As an example, the target may be a semiconductor material deposited on a stainless steel plate having the dimensions of an industry standard microtitre plate—i.e. 85.5×127.5 mm.

To summarize, the flat surface of the sample is brought into contact with the surface of the target. Over a period of minutes to hours, analyte is adsorbed from the sample onto the target surface. To improve the contact between the sample surface and the target surface a buffer solution is typically used. A thin layer of buffer solution is placed between the sample surface and the target. Analyte molecules, for example drug molecules, may migrate from the sample, through the buffer solution, to the target surface. In the preferred embodiment, the target surface is designed such that analyte molecules preferentially adsorb to the surface. As described above the target surface may be modified to present any functional group but, as an example, the semiconductor may be covered with a layer of fluorocarbon molecules or functional groups. As an example, the sample may be a microtome from animal tissue having a drug dispersed therein. Drug molecules from such a sample will tend to adsorb to the hydrophobic surface of the target whereas inorganic salts will tend to remain in the buffer solution. The layer of buffer solution may be of any desired thickness. However, in the preferred embodiment, the buffer solution should be as thin as possible while still insuring contact between the solution and both the sample and target surfaces. Lateral diffusion of analyte molecules during the process of migrating to the target surface will tend to blur the molecular image on the target. That is, the location of analyte on the target may not be representative of the analyte in the sample if lateral diffusion becomes important. Thus, excessively long incubation times and/or unnecessarily thick layers of buffer solution should be avoided.

In alternate embodiments, an electric potential may be applied between the target and the sample. This will tend to cause analyte in the sample to become charged and to migrate by electroosmosis. The potential should be applied such that ions having the charge of the desired analyte migrate toward the target. That is, the polarity of the analyte ions should be opposite the polarity of the potential applied to the target. Such methods, known as electroblotting, are well known in the prior art (see for example, Bienvenut W V, et al. Anal. Chem. 71(21), 4800(1999); and Binz P A et al, Anal. Chem. 71(21) 4981(1999)).

In step 34 the sample is washed. That is, the sample is removed from the target surface and the target surface is exposed to a clean solvent solution. The wash solution should be such that the analyte is substantially not desorbed from the target surface or dissolved in the solvent. However, a certain range of undesired compounds and contaminants should be soluble in the solvent and should thereby be removed from the target surface. As an example, the analyte in the sample might be a hydrophobic drug and the target surface modified to present a hydrophobic surface. After blotting, the target could be washed with pure water. Hydrophilic compounds, for example, inorganic salts, would be washed away from the target, however, hydrophobic compounds, including the drug would remain adsorbed to the target.

Alternatively, the sample is not washed. Rather, all material on the target from the sample, including any extraneous sample compounds are retained. The target is simply allowed to dry and then inserted into the mass spectrometer.

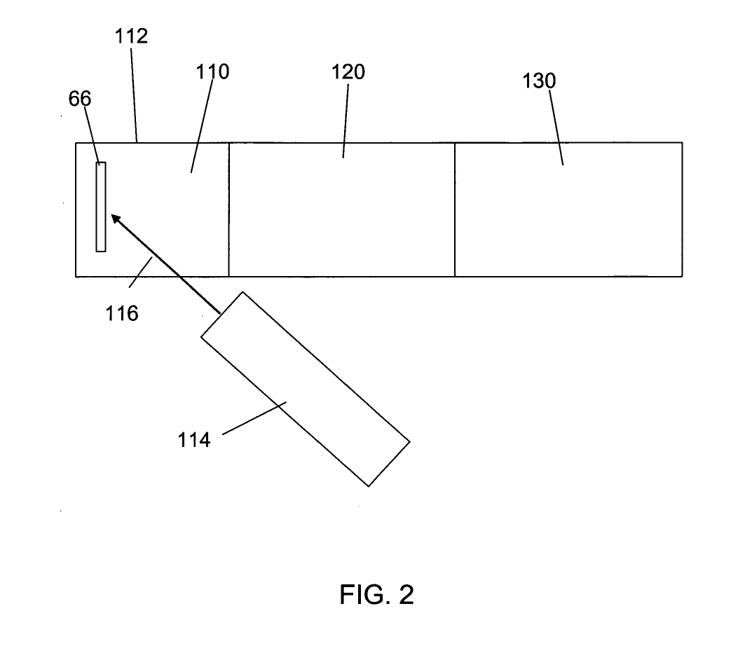

In step 36 the target is loaded into the instrument. The instrument as depicted in FIG. 2 may be any type of mass spectrometer which includes a laser 114, an ionization region 110, an ion transport region 120, and a mass analyzer 130. In alternate embodiments, ionization region 110, ion transport region 120, and mass analyzer 130 may all occupy the same chamber of the instrument. In some embodiments, the ionization means may be integral to the mass analyzer, and ion transport region 120 is thereby effectively eliminated. A wide range of mass spectrometers might be used in conjunction with the present invention. However, as an example, ionization region 110 may be a chamber 112 that is maintained at a pressure of 2 mbar. Target 66 is loaded into the chamber such that it is a proper position to receive light 116 from laser 114. Laser light 116 from laser 114 penetrates chamber 112 through a window (not shown). Ions formed from analyte on the target are transported from region 110 through transport region 120, and into mass analyzer 130 by gas dynamics and ion optics. Such ion optics may include for example an RF ion guide. Further, region 120 may include a quadrupole ion guide, or other mass filter which can be used to select ions of interest. In further embodiments, region 120 may include a collision cell wherein ions can be induced to form fragment ions. As an example, region 120 might include multiple differential pumping stages, the last of which might be maintained at a pressure of about 10⁻⁵ mbar. Mass analyzer 130 might include further pumping and thereby be maintained at a pressure of 10⁻⁸ mbar. As an example, the mass analyzer might be an orthogonal time of flight mass analyzer.

In alternate embodiments, ionization region 110 may be held at atmospheric pressure. In such an embodiment, an orifice between regions 110 and 120 allows both gas and ions into the vacuum system. Thus, ion transport region 120 must include enough pumping capacity and proper ion optics to transport a useful fraction of the produced ions to mass analyzer 130 while eliminating nearly all the associated gas.

In yet another alternate embodiment, ionization region 110 is coextensive with mass analyzer 130 and ion transport region 120, and associated optics are effectively eliminated. A traditional laser desorption ionization time-of-flight (LDI-TOF) mass spectrometer is an example of such an instrument.

In further alternate embodiments, mass analyzer 130 might be any known type of mass analyzer including, but not limited to, an orthogonal time of flight mass analyzer, an axial time-of-flight mass analyzer, an ion cyclotron resonance mass analyzer, a quadrupole filter, a Paul trap, a rectilinear ion trap, or a magnetic or electric sector.

In further alternate embodiments, laser 114 may be any known type of laser appropriate for the target and analyte. That is, any type of laser might be used so long as the semiconductor material used to make the target adsorbs light at the wavelength produced by the laser and so long as ions can be produced from the analyte as a result of the laser irradiation of the target. Examples of such lasers include but are not limited to Nitrogen, CO₂, HeNe, Ar, Excimer, diode, and YAG lasers.

In step 36 of FIG. 1 target 66 is positioned in region 110 in a manner appropriate for the analysis of a first location on target 66. That is, target 66 is positioned such that laser light 116 from laser 114 can be focused onto the selected position on target 66 and such that ions produced from target 66 can be transported from target 66 to mass analyzer 130 and mass analyzed. As discussed above, the positioning and LDI mass analysis of targets in mass spectrometers is well known in the prior art.

In step 38, the first location on target 66 is irradiated with laser light 116 so as to induce the desorption and ionization of at least some of the analyte at the first location. The focus and power density of the laser light on the target must be controlled with lenses and attenuators to provide appropriate desorption/ionization conditions. The optimum lateral dimension of the laser beam 116 at target 66 and the optimum power density can be determined experimentally. The dimension of laser beam 116 will in part determine the spatial resolution with which the resulting mass spectrum can be associated with a position on the original sample.

In step 40, analyte ions produced from target 66 are mass analyzed and detected to produce a mass spectrum. If all of the pixels have not yet been analyzed, as determined in step 42, the target 66 is then positioned in a manner appropriate for the analysis of analyte at a second location on target 66 (step 44). Alternatively, target 66 might be kept in a fixed location and laser beam 116 might be aligned with the next position on target 66 to be analyzed. Steps 38 and 40 are repeated for each pixel until the analyte at all preselected locations on target 66 have been analyzed. In this way a series of mass spectra are produced each spectrum having associated with it a position on target 66. When, in step 42, all preselected locations of interest on target 66 have been analyzed, the acquisition of spectra is stopped.

A computer is used not only to control the instrument and the positioning of target 66, but also to record the resulting mass spectra. The various locations of interest on target 66 may be analyzed in any order. However, a record of the position on target 66 associated with each spectrum should also be maintained.

In step 46, the data are processed to associate mass signals in the mass spectra obtained in steps 36 through 44 with position on target 66 and thereby with locations in the original sample. This processing may be done in any conceivable manner and may be as simple as a user looking at a mass spectrum and directly associating signals in the spectrum with features at the corresponding location on sample 60.

In the exemplary embodiment, step 46 includes the generation of one or more mass images of the sample. Ions of a given mass appearing in the mass spectra represent a given type of analyte in the original sample. That is, for example, a first mass appearing in the mass spectra represents a first type of analyte in the original sample, a second mass appearing in the mass spectra represents a second type of analyte in the original sample, and so forth. Furthermore, the intensity of a mass signal appearing in a mass spectrum bears some relation to the concentration of the corresponding analyte in the original sample. Given the known relation between the spectra, the positions on the target from which the spectra were obtained, and the corresponding positions on the original sample, the distribution of analyte of a given mass in the original sample can be determined. That is, the intensity of the signal of a given mass of interest can be plotted as a function of position on the original sample. In this way a mass image of the analyte the original sample can be formed.

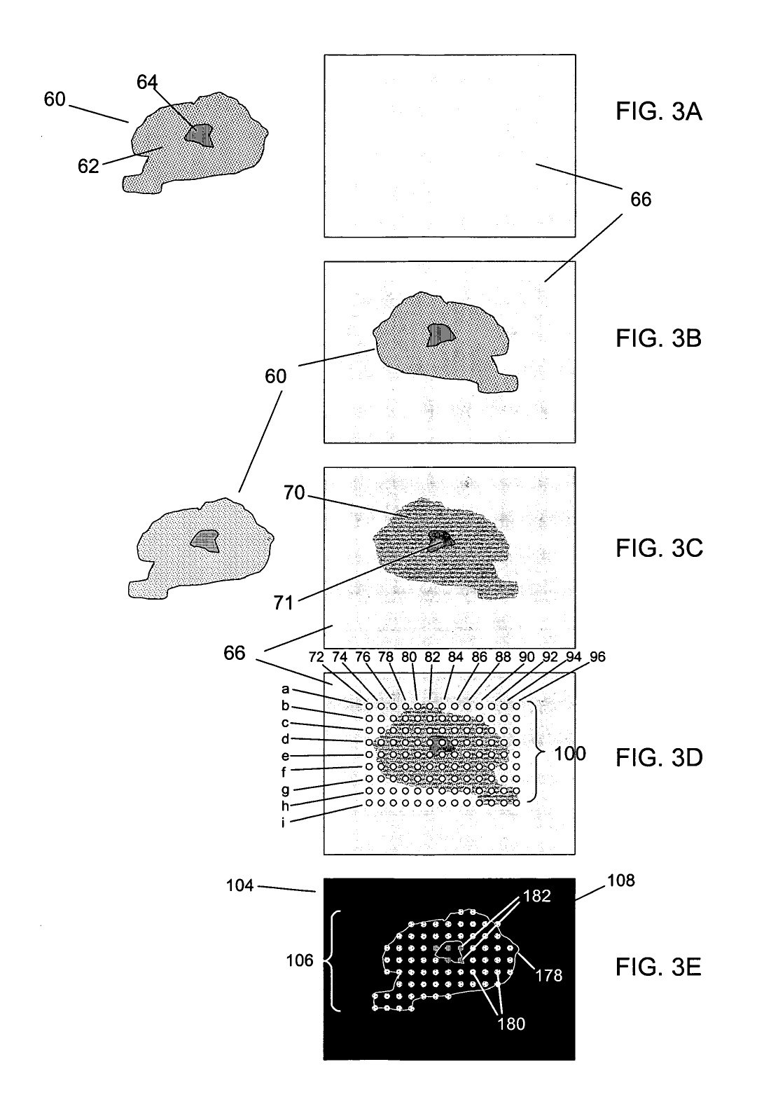

Referring next to FIGS. 3A-3E, a depiction of the preparation and mass analysis of a target according to the present invention is shown. In FIG. 3A sample 60 and target 66 are shown. Sample 60 may be material of any conceivable origin, such as a microtome slice from a tissue. Sample 60 may have certain first analytes concentrated in a first region 62 while analytes of a second type may be concentrated in a second region 64. For example, drug molecules might have a substantially higher concentration in region 64 than in region 62.

As discussed above, target 66 might be composed of any semiconductor material having a high surface to volume ratio. As an example, target 66 may be composed substantially of porous silicon as described by Siuzdak et al. in U.S. Pat. No. 6,288,390. The macroscopic dimensions of the target may be any selected dimension. As an example, the target may be a stainless steel plate having the dimensions of an industry standard microtitre plate—i.e. 85.5×127.5 mm. On this steel plate, porous silicon might be formed. Alternatively, nanowires might be grown according to the disclosure of U.S. patent application Ser. No. 11/117,702, or germanium might be deposited as described in U.S. Pat. No. 6,794,196.

Referring to FIG. 3B, sample 60 is placed face down on the surface of the target. As described above with reference to step 32, a buffer solution may be used to mediate the contact between sample 60 and target 66. Analyte molecules, for example drug molecules, may migrate from the sample, through the buffer solution, to the target surface. In the preferred embodiment, the target surface is designed such that analyte molecules preferentially adsorb to the surface. As described above, the target surface may be modified to present any functional group but, as an example, the semiconductor may be covered with a layer of fluorocarbon molecules or functional groups. The drug molecule will tend to adsorb to such a hydrophobic surface whereas inorganic salts will tend to remain in the buffer solution. The buffer solution may be of any desirable thickness. However, in the preferred embodiment, the buffer solution should be as thin as possible while still insuring contact between the solution and both the sample and target surfaces.

The sample may be incubated with the target for any desired length of time, such as a period of thirty minutes. During this time the sample and target are kept in a humid environment so that the buffer solution does not evaporate.

As depicted in FIG. 3C, following incubation, sample 60 is removed from target 66 and target 66 is washed. As described above with respect to step 34, the wash solution is preferably of such a composition that the analyte is largely retained on the target while undesirable or interfering species are washed away. A variety of wash solutions might be used. In the present example, pure water might be used to wash away away inorganic salts and other water soluble species while hydrophobic species like the analyte drug are retained on the target surface. Often, analyte species adsorbed on a target will not be visible. However, the adsorbed species in FIG. 3C are represented as a discoloration in regions 70 and 71. As an example, a first analyte may be deposited in region 70 and a second analyte may be retained substantially in region 71. It will be understood that, because sample 60 was placed face down on the target, the analyte distribution on the target, as shown in the figures, is a mirror image of that in the original sample.

Referring to FIG. 3D, target 66 is shown with adsorbed analyte and array of spots 100 corresponding to those locations on the target to be mass analyzed. The spots to be analyzed need not take the form of a rectangular array, and may be any desired set of locations. In the example of FIG. 3D, array 100 of spots, is composed of 108 locations, in the form of twelve columns, 72-96, and nine rows, a-i.

Initially, the target is positioned in the mass spectrometer in a manner appropriate for the analysis of a first location in array 100. That is, the target is positioned such that laser light from a laser can be focused onto the selected position on the target, and such that ions produced from the target can be transported from the target to the mass analyzer so that the ions can be mass analyzed. The positioning and LDI mass analysis of targets in mass spectrometers is well known in the prior art. As discussed with respect to step 38, the first location in array is irradiated with laser light so as to induce the desorption and ionization of at least some of the analyte in the first location. As described with respect to step 40, the ions produced are mass analyzed and detected to produce a mass spectrum. The target is then positioned in a manner appropriate for the analysis of the analyte at a second location in array 100. These steps are repeated until the analyte at all locations in array 100 have been analyzed. The various locations on the target represented in array 100 may be analyzed in any order. However, a record of the position on the target associated with each spectrum must be maintained. For the sake of convenience, position 72a might be taken to be the first position analyzed, position 74a might be taken to be the second position analyzed, and so forth, until all of the positions have been successively analyzed from left to right and from top to bottom in the array.

Referring next to FIG. 3E, shown is a depiction of a “mass image” of original sample 60 as produced using the mass spectra obtained from array 100. Ions of a given mass appearing in the mass spectra represent a given type of analyte in sample 60. That is, for example, a first mass appearing in the mass spectra represents a first type of analyte in sample 60, a second mass appearing in the mass spectra represents a second type of analyte in sample 60, and so forth. Furthermore, the intensity of a mass signal appearing in a mass spectrum bears some relation to the concentration of the corresponding analyte in the sample 60. Given the known relation between the mass spectra, positions 100 on target 66 from which the spectra were obtained, and the corresponding positions on sample 60, the distribution of analyte of a given mass in sample 60 can be determined. That is, the intensity of the signal of a given mass of interest can be plotted as a function of position on sample 60. In this way mass image 104 of the analyte in sample 60 is formed. In the example image of FIG. 3E, pixels 106 are plotted over outline 178 of the optical image of sample 60. Lighter pixels 180 represent the presence of analyte having a first mass, darker pixels 182 represent the presence of analyte having a second mass, and black background 108 represents an absence of signal from either the first or second selected masses.

The methods described above may be used in combination with appropriately modified surfaces in the analysis of a variety of types of samples. As described above a tissue sample might be analyzed to determine the spatial distribution of a drug.

As another example, the semiconductor surface of a target might be functionalized with short chain poly vinylidene difluoride—for example a 10 mer. Separately, a sample may be generated first by the one dimensional gel electrophoresis separation of a protein mixture, followed by the in-gel tryptic digestion of the separated proteins. Then, in accordance with the methods described above, the peptides are electroblotted from the gel onto the target. The target is then washed and analyzed as described above with respect to the present invention.

As yet another example, the semiconductor target might be functionalized with nickel-nitrilotriacetic acid or groups which have similar functionality when bound to the semiconductor surface. Such a functional group has a high affinity for proteins containing an affinity tag of six consecutive histidine residues. Blotting from a sample containing proteins will result in the preferential adsorption of those proteins containing six consecutive histidine residues. These proteins might thereafter be digested while still on the target following which the target could be analyzed. Alternatively, the nickel in the nitrilotriacetic acid groups might be replaced by gallium. Phosphopeptides could then be preferentially extracted from a sample onto the target.

Any functional group found to improve selectivity of a specific analyte or range of analytes might be used to modify the semiconductor surface of the target. These then might be applied to any desired sample material to extract and thereafter analyze the type and distribution of analytes in the sample.

While the present invention has been described with reference to one or more preferred and alternate embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method for analyzing a sample by mass spectrometry, the method comprising:
a) blotting an analyte from the sample onto a semiconductor target;
b) washing the target; and
c) analyzing the target by mass spectrometry.

2. A method according to claim 1 wherein the semiconductor target is selected from a group consisting of porous Si, Si nanowires and GaAs.

3. A method according to claim 2 wherein the target further comprises a thin coating of organic molecules covering the semiconductor target.

4. A method according to claim 2 wherein the surface of the target is modified by reaction with an organic or organometalic compound.

5. A method according to claim 4. wherein said compound is perfluorophenyldimethychlorosilane.

6. A method according to claim 3 wherein said coating is a self assembled monolayer.

7. A method according to claim 3 wherein said coating is a thin polymer coating.

8. A method according to claim 3 wherein said coating is hydrophobic.

9. A method according to claim 3 wherein said coating is hydrophilic.

10. A method according to claim 1 wherein the step of blotting the analyte onto the target further comprises:
a′) wetting the target with a thin film of buffer solution;
a″) bringing the sample into contact with the target via the buffer solution; and
a′″) incubating the sample with the target for a predetermined time.

11. A method according to claim 10 further comprising applying a potential between the sample and the target so as to drive the analyte out of the sample and onto the target.

12. A method according to claim 1 wherein the step of washing the target further comprises bringing the target into contact with a solution which will tend to solublize unwanted species but substantially leave the analyte adsorbed to the target.

13. A method according to claim 3 wherein the step of washing said target further comprises bringing the target into contact with a solution which will tend to solublize unwanted species but substantially leave the analyte adsorbed to the target.

14. A method according to claim 1 wherein the step of washing the target further comprises:
c′) positioning the target in a mass spectrometer;
c″) producing a series of mass spectra from an array of locations on the target, the locations corresponding to sample positions on the target during the blotting step; and
c′″) producing one or more images from said series of mass spectra, the image corresponding to the distribution of one or more analyte species on the target.

15. A method according to claim 14 wherein the mass spectrometer is a laser desorption mass spectrometer.

16. A method according to claim 14 wherein the mass spectrometer is a secondary ion mass spectrometer.

17. A method according to claim 1 wherein the sample is a tissue.

18. A method according to claim 18 wherein the tissue sample is produced by microtome.

19. A method according to claim 3 wherein said coating includes molecules designed to preferentially capture said analyte.

20. A method according to claim 1 wherein the analyte is selected from a group consisting of drugs, drug candidates, metabolites, peptides, and proteins.
